(19) United States
(12) Patent Application Publication
(10) Pub. No.: US 2024/0151918 A1
(43) Pub. Date: May 9, 2024

(54) SUB-MOUNT, OPTICAL MODULATION MODULE, AND OPTICAL COMMUNICATION DEVICE

(71) Applicant: ELECTRONICS AND TELECOMMUNICATIONS RESEARCH INSTITUTE, Daejeon (KR)

(72) Inventors: Jaegyu PARK, Daejeon (KR); Sungil KIM, Daejeon (KR); Sang-Pil HAN, Daejeon (KR)

(73) Assignee: ELECTRONICS AND TELECOMMUNICATIONS RESEARCH INSTITUTE, Daejeon (KR)

(21) Appl. No.: 18/487,513

(22) Filed: Oct. 16, 2023

(30) Foreign Application Priority Data
Nov. 4, 2022 (KR) 10-2022-0146240

(51) Int. Cl. G02B 6/42; H04B 10/50

(52) U.S. Cl. CPC G02B 6/4279; G02B 6/4257; G02B 6/428; H04B 10/504

(57) ABSTRACT

Disclosed are a sub-mount, an optical modulation module, and an optical communication device. The sub-mount includes a mount substrate, a signal electrode extending in a first direction on the mount substrate, and a ground electrode separated from the signal electrode and disposed on the mount substrate. Here, the ground electrode includes a lower electrode disposed on a bottom surface of the mount substrate and upper electrodes disposed on one side of the mount substrate and connected to the lower electrode through a side surface or the inside of the mount substrate.

### CROSS-REFERENCE TO RELATED APPLICATIONS

This U.S. non-provisional patent application claims priority under 35 U.S.C. § 119 of Korean Patent Application No. 10-2022-0146240, filed on Nov. 4, 2022, the entire contents of which are hereby incorporated by reference.

### BACKGROUND

The present disclosure relates to an optical communication device, and more particularly, to a sub-mount, an optical modulation module, and an optical communication device including the sub-mount and the optical modulation module.

In recent years, researches on photonics integrated circuits (PIC) capable of performing high-integrated, low-power, and ultrahigh-speed data processing in order to process rapidly increasing data in the fields of 5G/6G communications, data centers, and high performance computing (HPC) are actively conducted. To this end, many research results on various photonics devices such as optical modulators, optical switches, optical splitters, polarization controllers, and ring resonators are reported. Among the above-described photonics devices, the optical modulator serves to convert a large amount of data (electrical signal) into light. Thus, the optical modulator capable of ultrahigh-speed data conversion is required to be developed.

### SUMMARY

The present disclosure provides a sub-mount, an optical modulation module, and an optical communication device, which are capable of transmitting a data signal at ultrahigh speed.

The present disclosure discloses a sub-mount. An embodiment of the inventive concept provides a sub-mount including: a mount substrate; a signal electrode extending in a first direction on the mount substrate; and a ground electrode separated from the signal electrode and disposed on one side of the mount substrate. Here, the ground electrode includes: a lower electrode disposed on a bottom surface of the mount substrate; and upper electrodes disposed on one side of the mount substrate and connected to the lower electrode through a side surface or the inside of the mount substrate.

In an embodiment, the ground electrode may further include a via electrode disposed in the mount substrate to connect the upper electrodes to the lower electrode.

In an embodiment, the ground electrode may further include a side electrode disposed on a side surface of the mount substrate to connect the upper electrodes to the lower electrode.

In an embodiment, the ground electrode may further include buffer electrodes disposed between the signal electrode and the upper electrodes.

In an embodiment, the signal electrode may have a first protrusion disposed between the upper electrodes.

In an embodiment, the upper electrodes may have second protrusions disposed at both sides of the first protrusion.

In an embodiment, each of the second protrusions may be lower than the first protrusion.

In an embodiment, the buffer electrodes may have third protrusions disposed between the first protrusion and the second protrusions.

In an embodiment, each of the third protrusions may be lower than the first protrusion and higher than each of the second protrusions.

In an embodiment, the mount substrate may have a thickness of 0.254 mm, and the signal electrode may have a width of 0.254 mm.

In an embodiment of the inventive concept, an optical modulation module includes: a housing; a main substrate disposed in the housing; an optical modulator disposed on one side of the main substrate; and a sub-mount disposed on the other side of the main substrate and connected to the optical modulator. Here, the sub-mount includes: a mount substrate; a signal electrode extending in a first direction on the mount substrate; and a ground electrode separated from the signal electrode and disposed on one side of the mount substrate. Also, the ground electrode includes: a lower electrode disposed on a bottom surface of the mount substrate; and upper electrodes disposed on one side of the mount substrate and connected to the lower electrode through a side surface or the inside of the mount substrate.

In an embodiment, the main substrate may include a printed circuit board.

In an embodiment, the optical modulator may include a Mach-Zehnder modulator.

In an embodiment, the mount substrate may contain ceramic.

In an embodiment, the ground electrode may further include a via electrode disposed in the mount substrate or a side electrode disposed on a side surface of the mount substrate.

In an embodiment of the inventive concept, an optical communication device includes: a light source configured to generate light; an optical modulation module configured to modulate the light; an optical transmitter configured to transmit the modulated light; and a signal source connected to the optical modulator and configured to transmit a data signal to the optical modulator. Here, the optical modulation module includes: a housing; a main substrate disposed in the housing; an optical modulator disposed on one side of the main substrate; and a sub-mount disposed on the other side of the main substrate and connected to the optical modulator. Also, the sub-mount includes: a mount substrate; a signal electrode extending in a first direction on the mount substrate; and a ground electrode separated from the signal electrode and disposed on one side of the mount substrate. Also, the ground electrode includes: a lower electrode disposed on a bottom surface of the mount substrate; and upper electrodes disposed on one side of the mount substrate and connected to the lower electrode through a side surface or the inside of the mount substrate.

In an embodiment, the optical communication device may further include a cable configured to connect the signal source to the optical modulator.

In an embodiment, each of the upper electrodes may have a rectangular shape.

In an embodiment, the upper electrodes may have a comb shape.

In an embodiment, each of the upper electrodes may have a width of 0.1 mm to 0.4 mm.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a view illustrating an example of an optical communication device according to an embodiment of the inventive concept;

FIG. 2 is a view illustrating an example of an optical modulator and a sub-mount in FIG. 1;

FIG. 3A is a plan view illustrating an example of the sub-mount in FIG. 2;

FIG. 3B is a cross-sectional view illustrating an example of mount ground electrodes in FIG. 3A;

FIGS. 3C and 3D are graphs showing S parameters of the sub-mount of FIGS. 3A and 3B;

FIG. 4A is a plan view illustrating an example of the sub-mount in FIG. 2;

FIG. 4B is a cross-sectional view illustrating an example of the mount ground electrodes in FIG. 4A;

FIGS. 4C and 4D show S parameters of the sub-mount of FIGS. 4A and 4B;

FIGS. 5A to 5C are a plan view and cross-sectional views illustrating an example of the sub-mount in FIG. 2;

FIG. 6A is a plan view illustrating an example of the sub-mount in FIG. 2;

FIG. 6B is a cross-sectional view illustrating an example of upper electrodes in FIG. 6A;

FIGS. 6C and 6D show S parameters of the sub-mount of FIGS. 6A and 6B;

FIGS. 7A and 7B are a plan view and a cross-sectional view illustrating an example of the sub-mount in FIG. 2;

FIGS. 7C and 7D are graphs showing S parameters of the sub-mount of FIGS. 7A and 7B;

FIG. 8 is a perspective view illustrating an example of the sub-mount in FIG. 2;

FIGS. 9A and 9B are perspective views illustrating an example of the sub-mount in FIG. 2;

FIGS. 10A and 10B are perspective views illustrating an example of the sub-mount in FIG. 2;

FIGS. 11A and 11B are perspective views illustrating an example of the sub-mount in FIG. 2;

FIGS. 12A and 12B are perspective views illustrating an example of the sub-mount in FIG. 2;

FIGS. 13A and 13B are perspective views illustrating an example of the sub-mount in FIG. 2; and

FIGS. 14A and 14B are perspective views illustrating an example of the sub-mount in FIG. 2.

### DETAILED DESCRIPTION

Hereinafter, preferred embodiments of the inventive concept will be described in detail with reference to the accompanying drawings. Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art Like reference numerals refer to like elements throughout.

In the following description, the technical terms are used only for explaining a specific exemplary embodiment while not limiting the present disclosure. In the specification, the terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components. Since preferred embodiments are provided below, the order of the reference numerals given in the description is not limited thereto.

Additionally, the embodiment in the detailed description will be described with sectional views as ideal exemplary views of the present invention. Also, in the figures, the dimensions of layers and regions are exaggerated for clarity of illustration. Accordingly, shapes of the exemplary views may be modified according to manufacturing techniques and/or allowable errors. Therefore, the embodiments of the present invention are not limited to the specific shape illustrated in the exemplary views, but may include other shapes that may be created according to manufacturing processes.

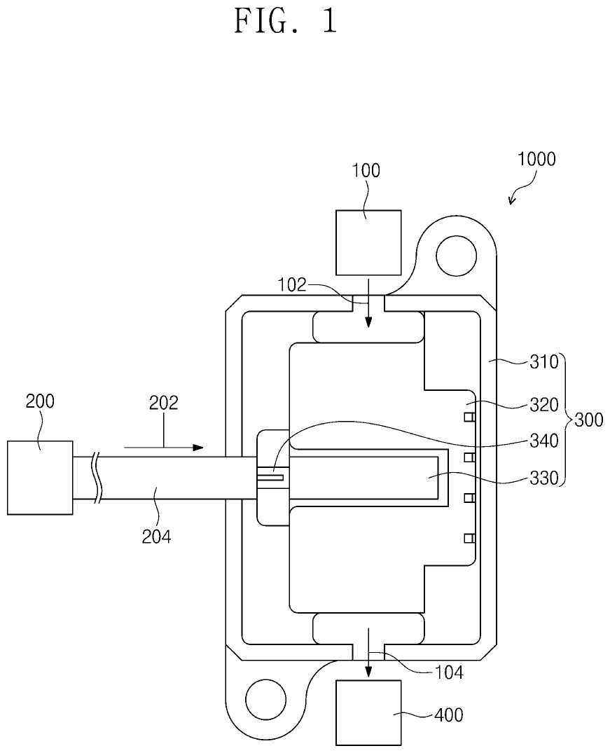

FIG. 1 is a view illustrating an example of an optical communication device 1000 according to an embodiment of the inventive concept.

Referring to FIG. 1, the optical communication device 1000 according to an embodiment of the inventive concept may include a light source 100, a signal source 200, an optical modulation module 300, and an optical transmitter 400.

The light source 100 may generate light 102. The light source 100 may provide the light 102 to the optical modulation module 300. The light 102 may include visible or infrared continuous wave laser light. For example, the light source 100 may include all sorts of coherent light sources such as a DFB laser or a tunable laser.

The signal source 200 may generate a data signal 202. The signal source 200 may provide the data signal 202 to the optical modulation module 300 through a cable 204. For example, the signal source 200 may include CPU, GPU, or AP. Alternatively, the signal source 200 may include a sensor or a modem. However, the embodiment of the inventive concept is not limited thereto.

The optical modulation module 300 may be connected to the light source 100, the signal source 200, and the optical transmitter 400. The light modulation module 300 may modulate the light 102 by using the data signal 202 to generate an optical signal 104. According to an embodiment, the optical modulation module 300 may include a housing 310, a main substrate 320, an optical modulator 330, and a sub-mount 340.

The housing 310 may accommodate and/or store the main substrate 320, the optical modulator 330, and the sub-mount 340. For example, the housing 310 may include a metal case. However, the embodiment of the inventive concept is not limited thereto.

The main substrate 320 may support and fix the optical modulator 330 and the sub-mount 340. The main substrate 320 includes a metal substrate. Each of the main substrate 320 and the housing 310 may be used as a ground terminal. Alternatively, the main substrate 320 may include a printed circuit board. However, the embodiment of the inventive concept is not limited thereto.

The optical modulator 330 may be disposed on the main substrate 320. The optical modulator 330 may modulate the light 102 by using the data signal 202 to generate the optical signal 104. The optical signal 104 may include pulsed laser light.

The sub-mount 340 may be disposed between the optical modulator 330 and the signal source 200. The sub-mount 340 may connect the cable 204 of the signal source 200 to the optical modulator 330.

The optical transmitter 400 may be connected to the optical modulator 330. The optical transmitter 400 may transmit the optical signal 104 to the outside. For example, the optical transmitter 400 may include an optical fiber or an optical waveguide. However, the embodiment of the inventive concept is not limited thereto.

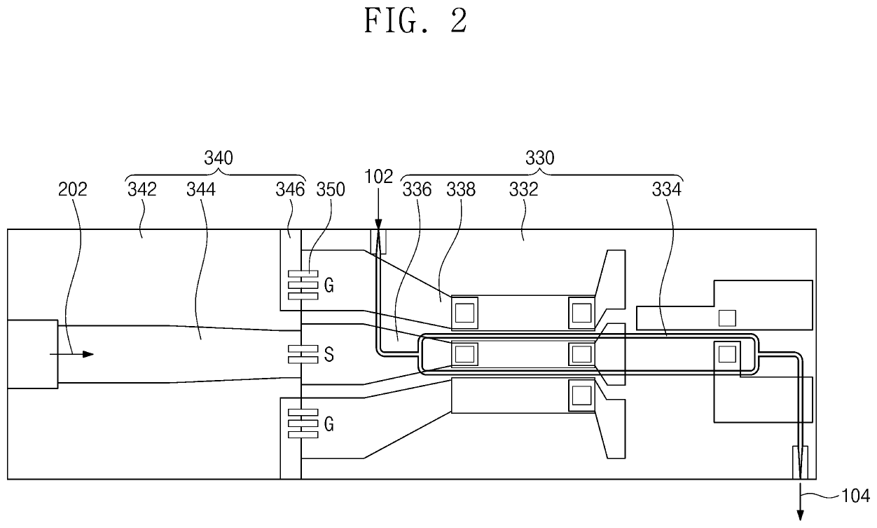

FIG. 2 is a view illustrating an example of the optical modulator 330 and the sub-mount 340 in FIG. 1.

Referring to FIG. 2, the optical modulator 330 and the sub-mount 340 may be connected to each other by wires 350. Each of the optical modulator 330 and the sub-mount 340 may have a characteristic resistance of about 50Ω.

The optical modulator 330 may include a Mach-Zehnder modulator. The optical modulator 330 may include a modulator substrate 332, optical waveguides 334, a modulation signal electrode 336, and modulation ground electrodes 338.

The modulator substrate 332 may mount the optical waveguides 334, the modulation signal electrode 336, and modulation ground electrodes 338 thereon. The modulator substrate 332 may include a silicon substrate or a glass substrate.

The optical waveguides 334 may be disposed on the modulator substrate 332. The optical waveguides 334 may include an input waveguide, branch waveguides, and an output waveguide. The input waveguide may receive the light 102. The branch waveguides may be branched from the input waveguide and connected to the output waveguide. The branch waveguides may transmit the light 102. The branch waveguides may change a phase of the light 102 by using the data signal 202. The light 102 may be interfered in a coupler disposed between the branch waveguides and the output waveguide. The light 102 may be modulated into the optical signal 104 by destructive and constructive interference. The output waveguide may output the optical signal 104 to the outside.

The modulation signal electrode 336 may be disposed between the branch waveguides. The modulation signal electrode 336 may receive the data signal 202 to induce an electric field between the signal electrode and the modulation ground electrodes 338. The electric field may adjust the phase of the light 102 by changing a refractive index of at least one of the branch waveguides.

The modulation ground electrodes 338 may be disposed at both sides of the branch waveguides. The modulation signal electrode 336 and the modulating ground electrodes 338 may induce an electric field in response to the data signal 202.

The sub-mount 340 may be disposed at one side of the modulator substrate 332 of the optical modulator 330. The sub-mount 340 may be connected to the modulation signal electrode 336 and the modulation ground electrodes 338. The sub-mount 340 may transmit the data signal 202 to the modulation signal electrode 336. According to an embodiment, the sub-mount 340 may include a mount substrate 342, a mount signal electrode 344, and mount ground electrodes 346.

The mount substrate 342 may mount the mount signal electrode 344 and the mount ground electrodes 346 thereon. The mount substrate 342 may contain Al₂O₃, AlN, high resistance Si, plastic or polymer. Alternatively, the mount substrate 342 may contain ceramic. However, the embodiment of the inventive concept is not limited thereto. The mount substrate 342 may have a thickness of about 0.254 mm.

The mount signal electrode 344 may be disposed on the mount substrate 342. The mount signal electrode 344 may extend in one direction. The mount signal electrode 344 may be tapered in a direction toward the mount ground electrodes 346. The mount signal electrode 344 may be connected to modulation signal electrode 336 by the wires 350. The mount signal electrode 344 may have the same width as the mount substrate 342. The mount signal electrode 344 may have a width of about 0.254 mm.

The mount ground electrodes 346 may be disposed at one side of the mount substrate 342. The mount ground electrodes 346 may be disposed at both sides of the mount signal electrode 344, respectively. The mount ground electrodes 346 may be spaced a predetermined distance from the mount signal electrode 344. The mount signal electrodes 346 may be connected to the modulation ground electrodes 338 by the wires 350.

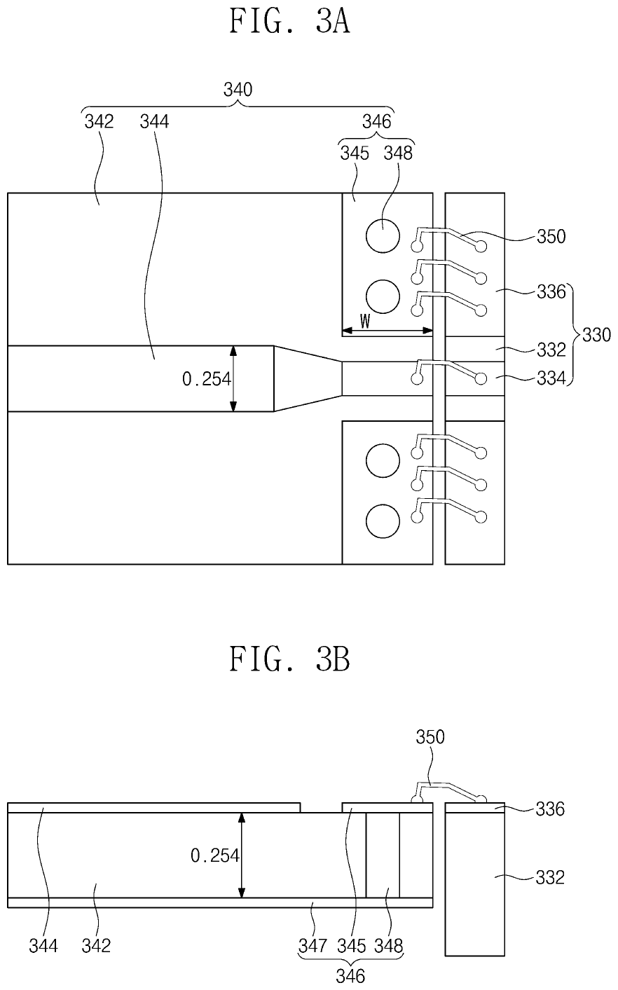

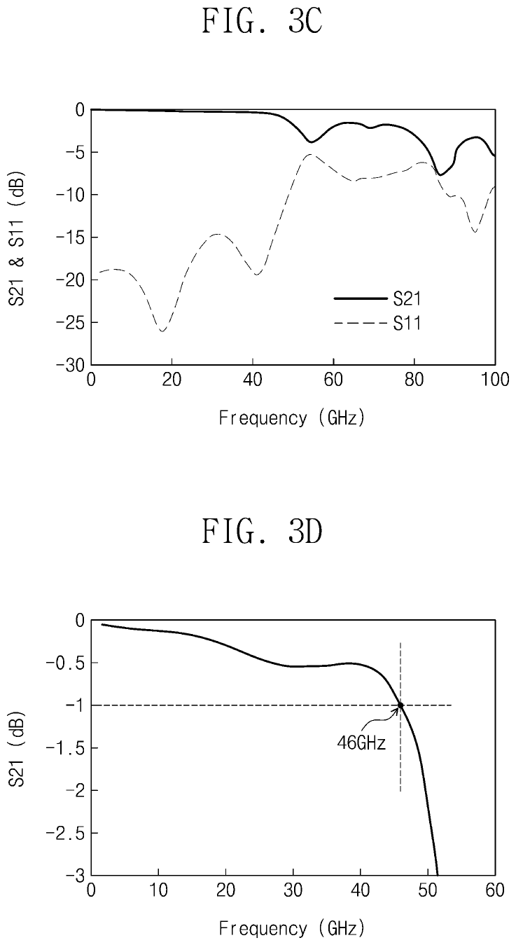

FIG. 3A is a view illustrating an example of the sub-mount 340 in FIG. 2. FIG. 3B is a view illustrating an example of the mount ground electrodes 346 in FIG. 3A.

Referring to FIGS. 3A and 3B, the mount ground electrodes 346 may include upper electrodes 345, a lower electrode 347, and a via electrode 348. The mount substrate 342 and the mount signal electrode 344 of the sub-mount 340 may be configured in the same manner as those in FIG. 2.

The upper electrodes 345 may be disposed on one side of the mount substrate 342. The upper electrodes 345 may be disposed at both sides of the mount signal electrode 344, respectively. Each of the upper electrodes 345 may have a rectangular shape from a plan view perspective. The upper electrodes 345 may be connected to the modulation ground electrodes 338 by the wires 350. Each of the upper electrodes 345 may have a width W of about 0.4 mm.

The lower electrode 347 may be disposed over an entire bottom surface of the mount substrate 342. The lower electrode 347 may be connected to the upper electrodes 345 through the via electrode 348.

The via electrode 348 may pass through the inside of the mount substrate 342 and connect the upper electrode 345 to the lower electrode 347.

The mount substrate 342 and the mount signal electrode 344 of the sub-mount 340 may be configured in the same manner as those in FIG. 2.

FIGS. 3C and 3D show S parameters of the sub-mount 340 of FIGS. 3A and 3B.

Referring to FIGS. 3A and 3D, the sub-mount 340 may have a resonance peak frequency of about 46 GHz with respect to the data signal 202. That is, the sub-mount 340 may transmit the data signal 202 at a maximum processing speed of about 46 GHz.

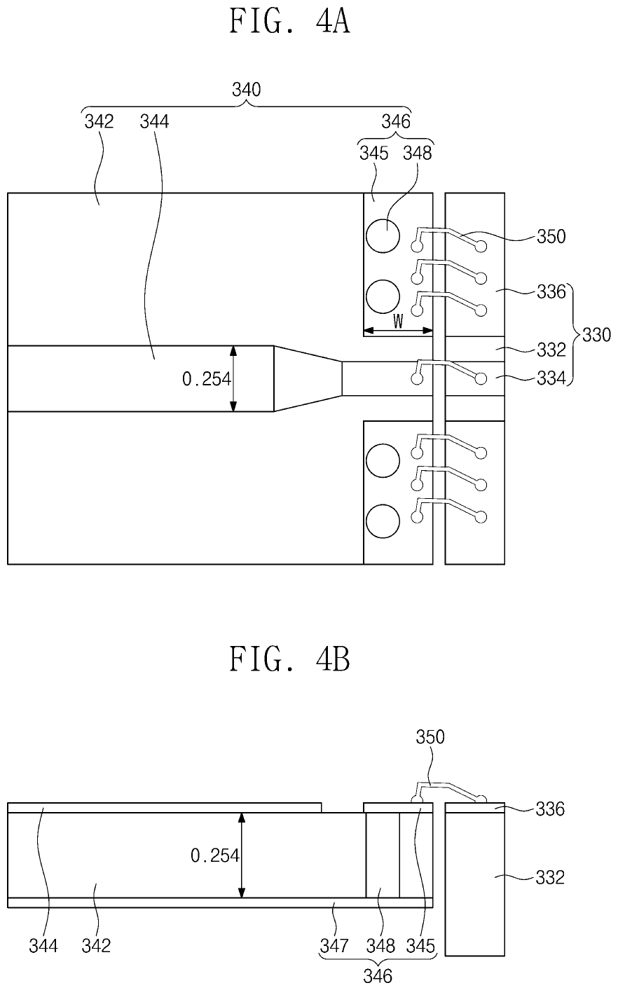

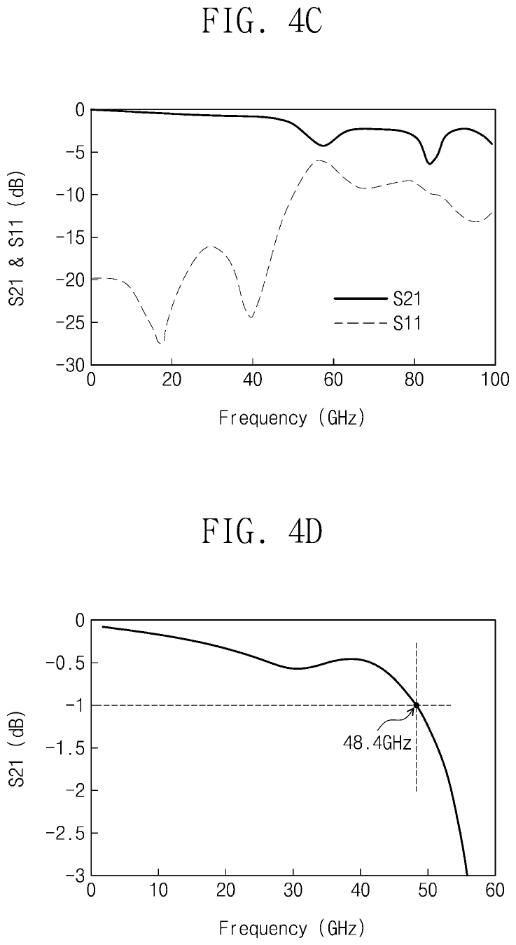

FIG. 4A is a view illustrating an example of the sub-mount 340 in FIG. 2. FIG. 4B is a view illustrating an example of the mount ground electrode 346 in FIG. 4A. FIGS. 4C and 4D show S parameters of the sub-mount 340 of FIGS. 4A and 4B.

Referring to FIGS. 4A to 4D, transmission characteristics of the data signal 202 of the sub-mount 340 may be inversely proportional to the width W of the upper electrode 345. When the upper electrode 345 has a width W of about 0.3 mm, the sub-mount 340 may have a resonant peak frequency of about 48.4 GHz for the data signal 202.

The mount substrate 342 and the mount signal electrode 344 of the sub-mount 340 may be configured in the same manner as those in FIG. 2. The lower electrode 347 and the via electrode 348 of the mount ground electrode 346 may be configured in the same manner as those in FIGS. 3A and 3B.

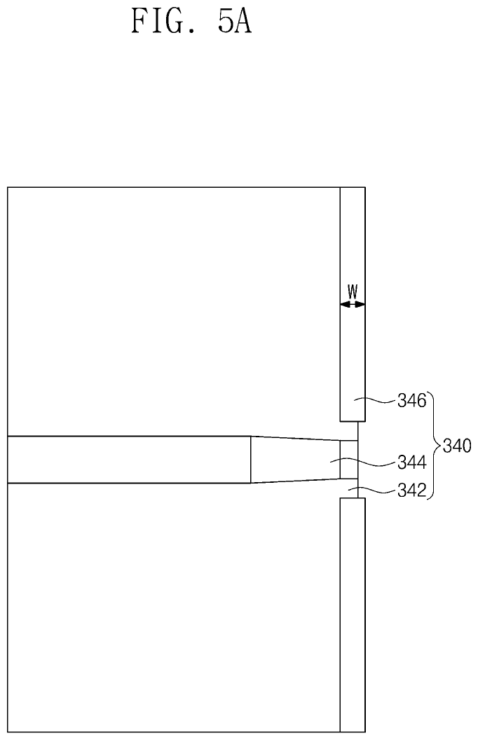

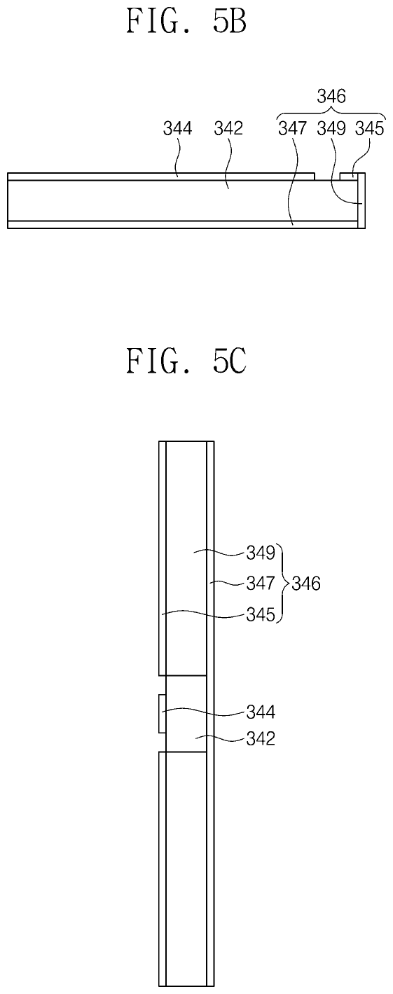

FIG. 5A is a view illustrating an example of the sub-mount 340 in FIG. 2.

Referring to FIGS. 5A to 5C, the sub-mount 340 may further include side electrodes 349. The side electrodes 349 may be disposed on one sidewall of the mount substrate 342. The side electrodes 349 may connect the upper electrodes 345 to the lower electrode 347. The side electrodes 349 may remove or minimize a limitation of a thickness of each of the via electrodes 348 and the width W of each of the upper electrodes 345 of FIGS. 3B and 4B. For example, each of the upper electrodes 345 may have a width W of about 0.1 mm or less.

The mount substrate 342 and the mount signal electrode 344 of the sub-mount 340 may be configured in the same manner as those in FIG. 2.

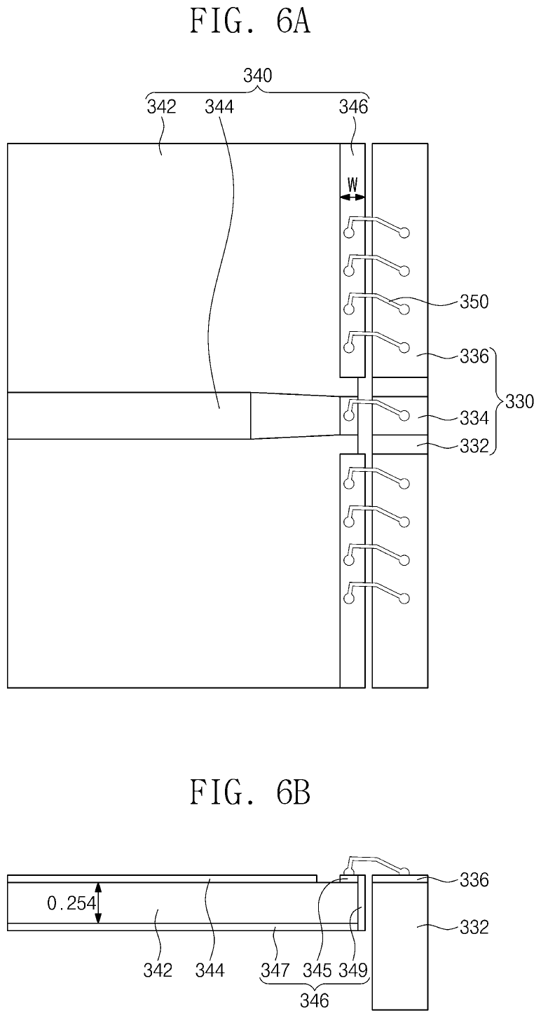

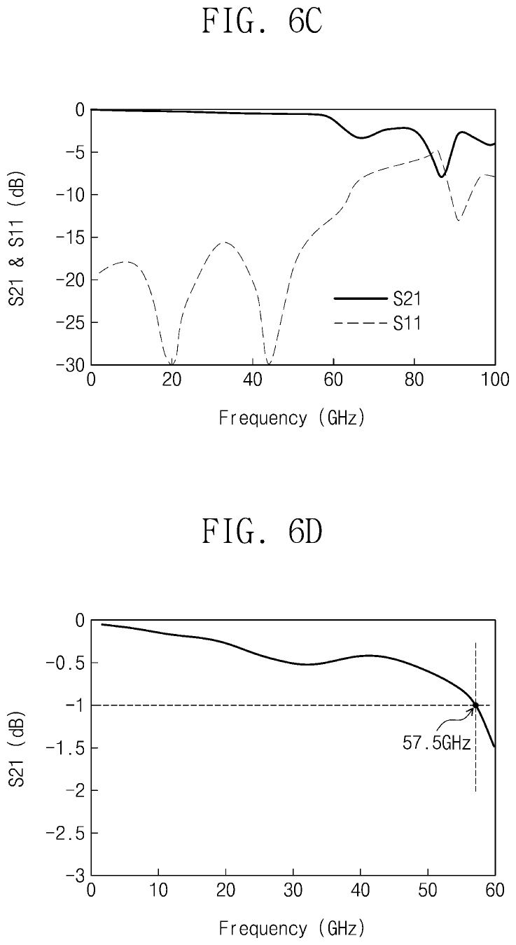

FIG. 6A is a view illustrating an example of the sub-mount 340 in FIG. 2. FIG. 6B is a view illustrating an example of the upper electrode 345 in FIG. 6A. FIGS. 6C and 6D show S parameters of the sub-mount 340 of FIGS. 6A and 6B.

Referring to FIGS. 6A to 6D, the upper electrodes 345 each having the width W of about 0.103 mm may increase the maximum processing speed of the sub-mount 340 to about 57.5 GHz.

Thus, the sub-mount 340 according to an embodiment of the inventive concept may transmit the data signal 202 to the optical modulator 330 with ultrahigh speed by using the via electrode 348 or the side electrode 349 that connects the upper electrodes 345 of the mount ground electrode 346 to the lower electrode 347.

The mount substrate 342 and the mount signal electrode 344 of the sub-mount 340 may be configured in the same manner as those in FIG. 2. The lower electrode 347 and the via electrode 349 of the mount ground electrode 346 may be configured in the same manner as those in FIGS. 5A and 5B.

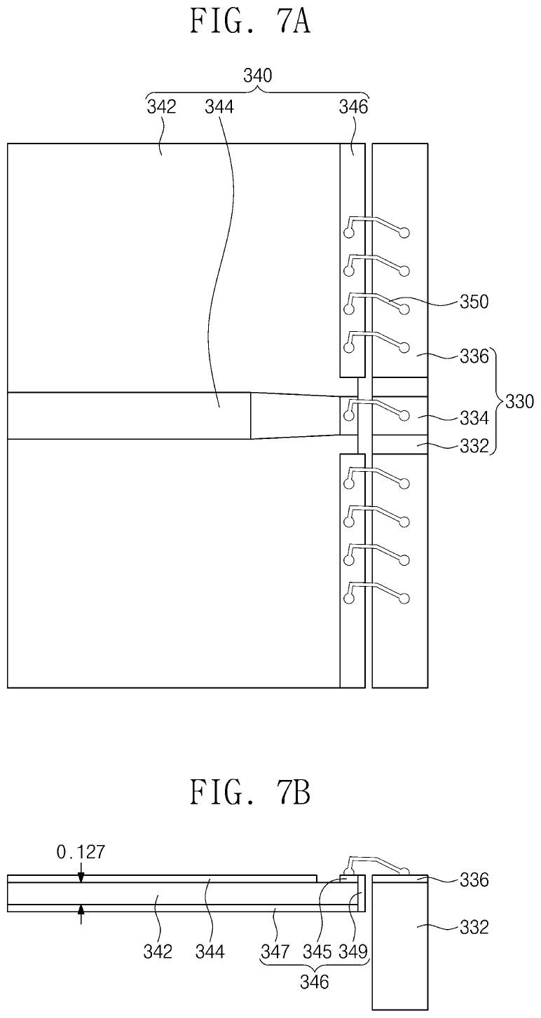

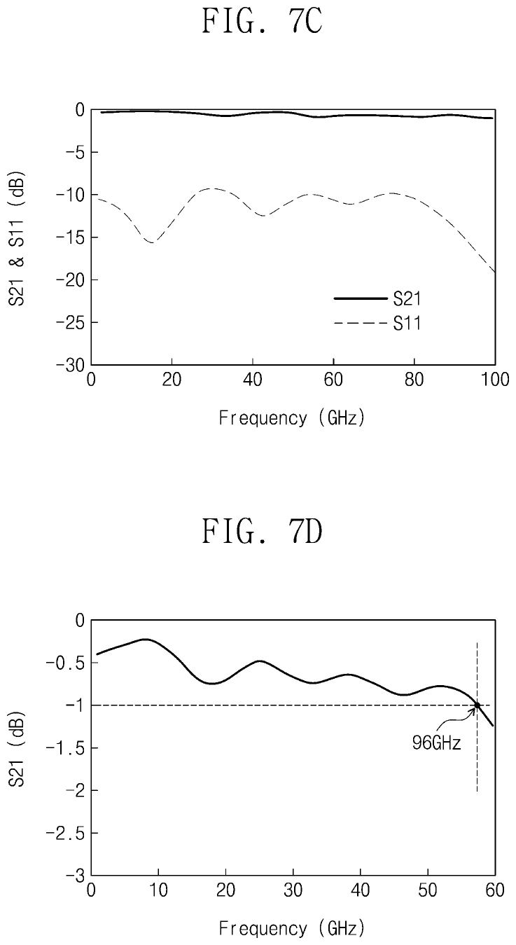

FIGS. 7A and 7B are views illustrating an example of the sub-mount 340 in FIG. 2. FIGS. 7C and 7D show S parameters of the sub-mount 340 of FIGS. 7A and 7B.

Referring to FIGS. 7A to 7D, the sub-mount 340 may increase a maximum processing speed of the data signal 202 in inverse proportion to a thickness of the mount substrate 342. For example, the mount substrate 342 having a thickness of about 0.127 mm may increase the maximum process speed of data signal 202 to about 96 GHz.

The mount signal electrode 344 and the mount ground electrode 346 of the sub-mount 340 may be configured in the same manner as those in FIGS. 5A and 5B.

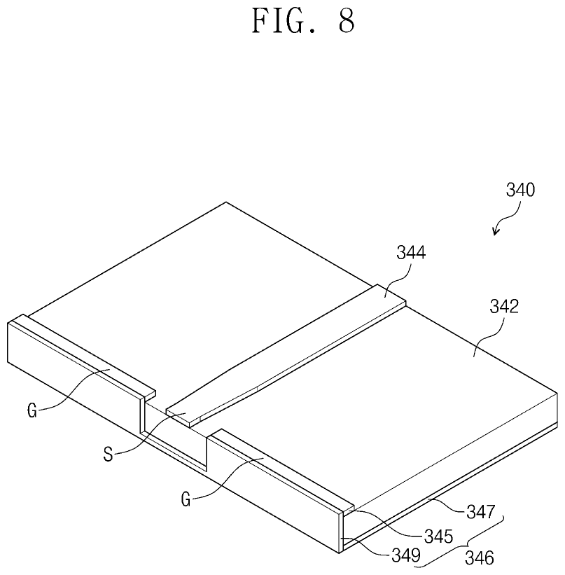

FIG. 8 is a view illustrating an example of the sub-mount 340 in FIG. 2.

Referring to FIG. 8, the side electrodes 349 of the mount ground electrode 346 may be removed from below the mount signal electrode 344.

The upper electrodes 345 and the lower electrode 347 of the mount ground electrode 346 may be configured in the same manner as those in FIGS. 5A and 5B.

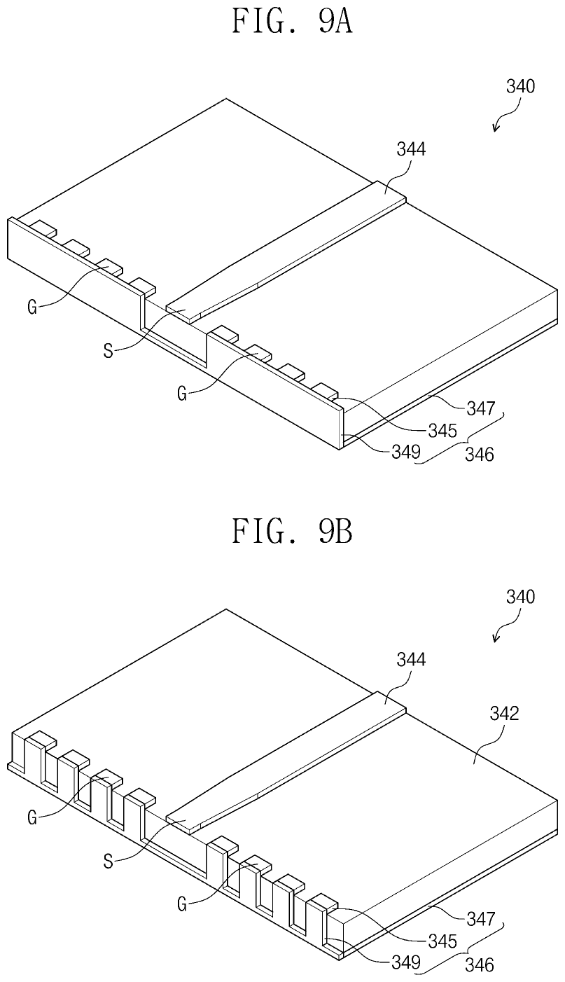

FIGS. 9A and 9B are views illustrating an example of the sub-mount 340 in FIG. 2.

Referring to FIGS. 9A and 9B, the upper electrodes 345 or the mount ground electrodes 346 of the sub-mount 340 may have a comb shape. The upper electrodes 345 may be arranged at equal intervals. Likewise, the mount ground electrodes 346 may be arranged at equal intervals.

The lower electrode 347 of the mount ground electrode 346 and the mount substrate 342 may be configured in the same manner as those in FIGS. 5A and 5B.

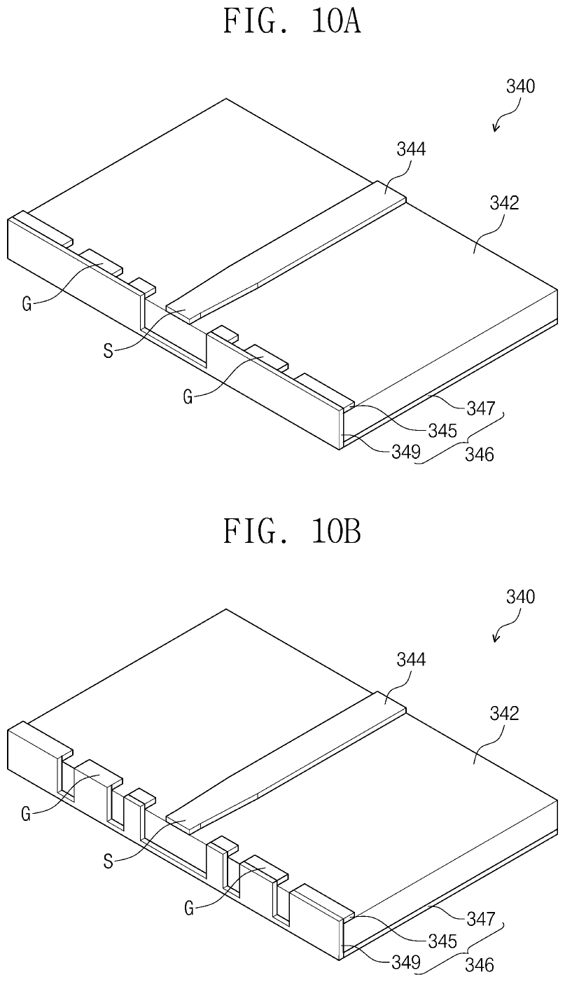

FIGS. 10A and 10B are views illustrating an example of the sub-mount 340 in FIG. 2.

Referring to FIGS. 10A and 10B, the upper electrodes 345 and the side electrodes 349 of the sub-mount 340 may have a comb shape. The upper electrodes 345 may increase in size in proportion to a distance from the mount signal electrode 344 from a plan view perspective.

The lower electrode 347 of the mount ground electrode 346 and the mount substrate 342 may be configured in the same manner as those in FIGS. 5A and 5B.

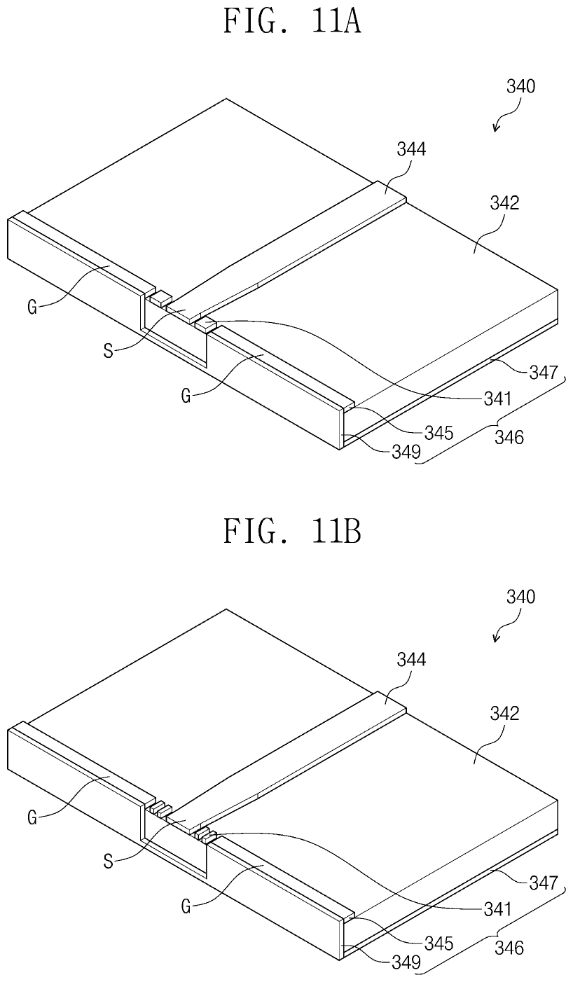

FIGS. 11A and 11B are views illustrating an example of the sub-mount 340 in FIG. 2.

Referring to FIGS. 11A and 11B, the sub-mount 340 may further include buffer electrodes 341. The buffer electrodes 341 may be disposed between the mount signal electrode 344 and the upper electrodes 345. The buffer electrodes 341 may be floating electrodes.

The lower electrode 347 of the mount ground electrode 346 and the mount substrate 342 may be configured in the same manner as those in FIGS. 5A and 5B.

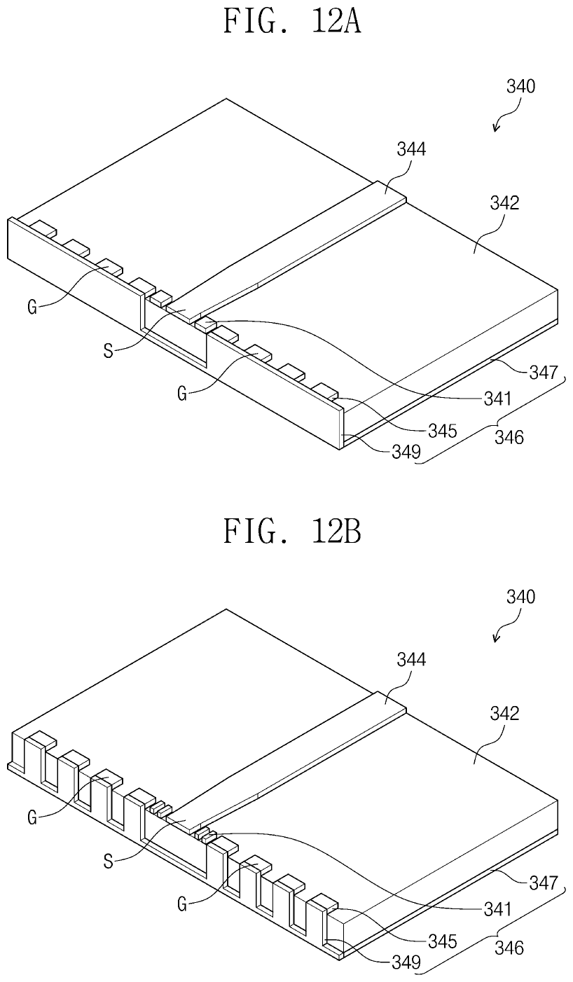

FIGS. 12A and 12B are views illustrating an example of the sub-mount 340 in FIG. 2.

Referring to FIGS. 12A and 12B, the buffer electrodes 341, the signal electrodes 344, and the upper electrodes 345 may have a comb shape.

The lower electrode 347 of the mount ground electrode 346 and the mount substrate 342 may be configured in the same manner as those in FIGS. 5A and 5B.

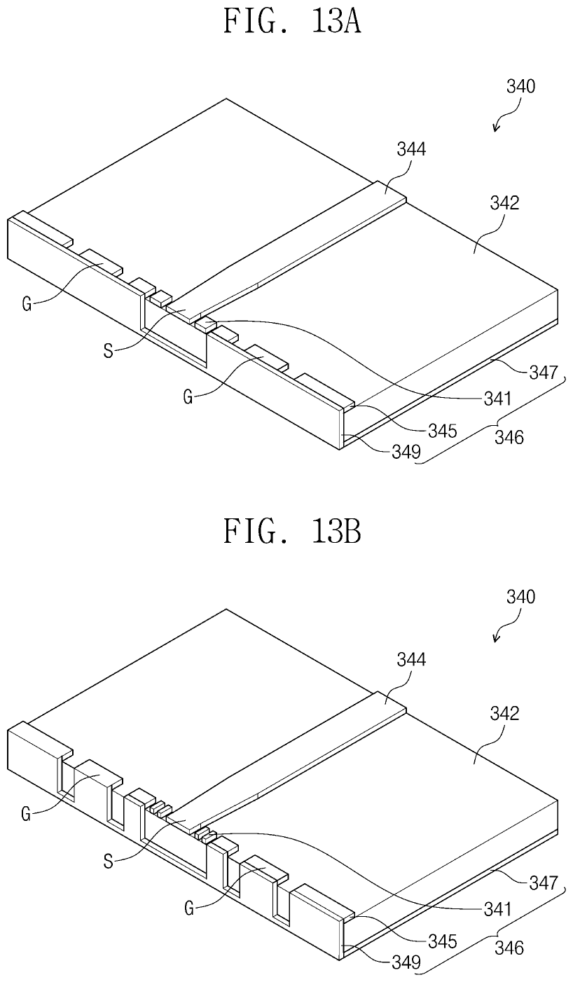

FIGS. 13A and 13B are views illustrating an example of the sub-mount 340 in FIG. 2.

Referring to FIGS. 13A and 13B, areas of the buffer electrodes 341 and the upper electrodes 345 may increase in proportion to a distance from the signal electrodes 344.

The lower electrode 347 of the mount ground electrode 346 and the mount substrate 342 may be configured in the same manner as those in FIGS. 5A and 5B.

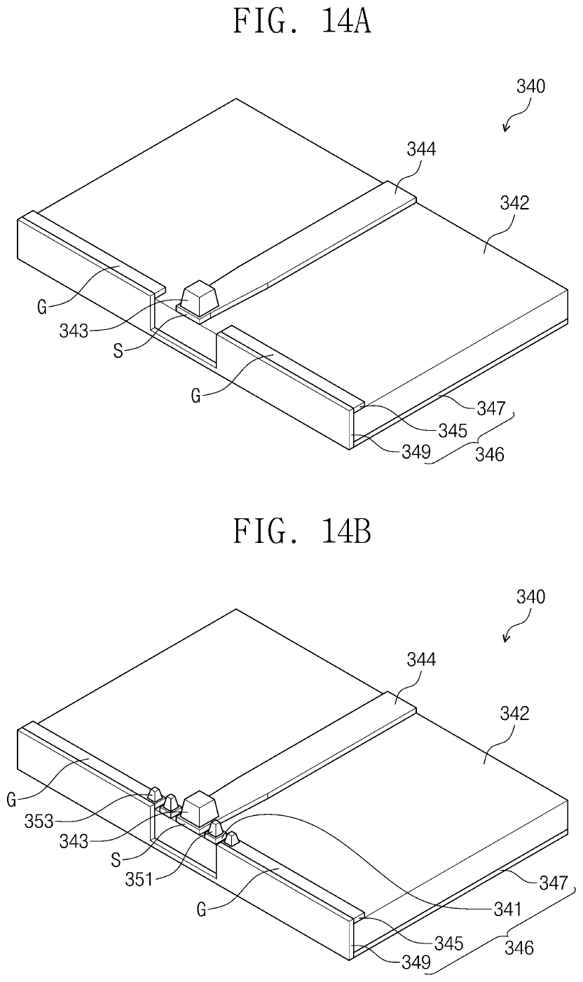

FIGS. 14A and 14B are views illustrating an example of the sub-mount 340 in FIG. 2.

Referring to FIGS. 13A and 13B, the mount signal electrode 344 may have a first protrusion 343, the buffer electrodes 341 may have second protrusions 351, and the upper electrodes 345 may have third protrusions 353.

The lower electrode 347 of the mount ground electrode 346 and the mount substrate 342 may be configured in the same manner as those in FIGS. 5A and 5B.

The first protrusion 343 may be disposed on an end of the mount signal electrode 344. The first protrusion 343 may be higher or thicker than each of the second protrusions 351 and the third protrusions 353. The second protrusions 351 may be disposed on the buffer electrodes 341. Each of the second protrusions 351 may be lower than the first protrusion 343 and higher than each of the third protrusions 353.

The third protrusions 353 may be disposed on the upper electrodes 345 adjacent to the second protrusions 351. Each of the third protrusions 353 may be lower or thinner than the first protrusion 343 and each of the second protrusions 351.

As described above, the sub-mount according to the embodiment of the inventive concept may transmit the data signal at ultrahigh speed by using the via electrode or the side electrode connecting the upper electrodes of the mount ground electrode to the lower electrode.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed. Therefore, the preferred embodiments should be considered in descriptive sense only and not for purposes of limitation.

What is claimed is:

1. A sub-mount comprising:
a mount substrate;
a signal electrode extending in a first direction on the mount substrate; and
a ground electrode separated from the signal electrode and disposed on one side of the mount substrate,
wherein the ground electrode comprises:
a lower electrode disposed on a bottom surface of the mount substrate; and
upper electrodes disposed on one side of the mount substrate and connected to the lower electrode through a side surface or the inside of the mount substrate.

2. The sub-mount of claim 1, wherein the ground electrode further comprises a via electrode disposed in the mount substrate to connect the upper electrodes to the lower electrode.

3. The sub-mount of claim 1, wherein the ground electrode further comprises a side electrode disposed on a side surface of the mount substrate to connect the upper electrodes to the lower electrode.

4. The sub-mount of claim 3, wherein the ground electrode further comprises buffer electrodes disposed between the signal electrode and the upper electrodes.

5. The sub-mount of claim 4, wherein the signal electrode has a first protrusion disposed between the upper electrodes.

6. The sub-mount of claim 5, wherein the upper electrodes have second protrusions disposed at both sides of the first protrusion.

7. The sub-mount of claim 6, wherein each of the second protrusions is lower than the first protrusion.

8. The sub-mount of claim 6, wherein the buffer electrodes have third protrusions disposed between the first protrusion and the second protrusions.

9. The sub-mount of claim 8, wherein each of the third protrusions is lower than the first protrusion and higher than each of the second protrusions.

10. The sub-mount of claim 1, wherein the mount substrate has a thickness of 0.254 mm, and
the signal electrode has a width of 0.254 mm.

11. An optical modulation module comprising:
a housing;
a main substrate disposed in the housing;
an optical modulator disposed on one side of the main substrate; and
a sub-mount disposed on the other side of the main substrate and connected to the optical modulator,
wherein the sub-mount comprises:
a mount substrate;
a signal electrode extending in a first direction on the mount substrate; and
a ground electrode separated from the signal electrode and disposed on one side of the mount substrate,
wherein the ground electrode comprises:
a lower electrode disposed on a bottom surface of the mount substrate; and
upper electrodes disposed on one side of the mount substrate and connected to the lower electrode through a side surface or the inside of the mount substrate.

12. The optical modulation module of claim 11, wherein the main substrate comprises a printed circuit board.

13. The optical modulation module of claim 11, wherein the optical modulator comprises a Mach-Zehnder modulator.

14. The optical modulation module of claim 11, wherein the mount substrate contains ceramic.

15. The optical modulation module of claim 11, wherein the ground electrode further comprises a via electrode disposed in the mount substrate or a side electrode disposed on a side surface of the mount substrate.

16. An optical communication device comprising:
a light source configured to generate light;
an optical modulation module configured to modulate the light;
an optical transmitter configured to transmit the modulated light; and
a signal source connected to the optical modulator and configured to transmit a data signal to the optical modulator,
wherein the optical modulation module comprises:
a housing;
a main substrate disposed in the housing;
an optical modulator disposed on one side of the main substrate; and
a sub-mount disposed on the other side of the main substrate and connected to the optical modulator,
wherein the sub-mount comprises:
a mount substrate;
a signal electrode extending in a first direction on the mount substrate; and
a ground electrode separated from the signal electrode and disposed on one side of the mount substrate,
wherein the ground electrode comprises:
a lower electrode disposed on a bottom surface of the mount substrate; and
upper electrodes disposed on one side of the mount substrate and connected to the lower electrode through a side surface or the inside of the mount substrate.

17. The optical communication device of claim 16, further comprising a cable configured to connect the signal source to the optical modulator.

18. The optical communication device of claim 16, wherein each of the upper electrodes has a rectangular shape.

19. The optical communication device of claim 16, wherein the upper electrodes have a comb shape.

20. The optical communication device of claim 16, wherein each of the upper electrodes has a width of 0.1 mm to 0.4 mm.
